(19) United States
(12) Patent Application Publication
(10) Pub. No.: US 2024/0176065 A9
(43) Pub. Date: May 30, 2024

(54) FOVEAL IMAGE INVERTER

(71) Applicant: SCHOTT Corporation, Rye Brook, NY (US)

(72) Inventors: Kevin Tabor, Webster, MA (US); Paige Higby, Holland, MA (US); Paulette Onorato, Sudbury, MA (US)

(73) Assignee: SCHOTT Corporation, Rye Brook, NY (US)

(21) Appl. No.: 17/443,107

(22) Filed: Jul. 21, 2021

Related U.S. Application Data
(63) Continuation of application No. 16/406,905, filed on May 8, 2019, now Pat. No. 11,079,538.
Application No. 16/406,905 is a continuation of application No. 15/410,727, filed on Jan. 19, 2017, now Pat. No. 10,288,803.
(60) Provisional application No. 62/441,491, filed on Jan. 2, 2017.
(60) Provisional application No. 62/281,168, filed on Jan. 20, 2016.

(51) Int. Cl. G02B 6/06; G02B 6/44

(52) U.S. Cl. CPC G02B 6/06; G02B 6/449

(57) ABSTRACT

An image-conducting optical fiber bundle extends along a central bundle axis between image input and image output ends. The bundle is twisted along a portion of its length such that an image inputted into the image input end is angularly displaced about the central bundle axis before being outputted through the image output end. Each constituent optical fiber includes a cladding with a cladding diameter corresponding with the fiber diameter of that fiber and a core with a core diameter. The ratio of the core diameter to the cladding diameter defines a core-to-clad diameter ratio relative to each fiber. In various embodiments, at least one of fiber diameter and core-to-clad diameter ratio varies as a function of a fiber's radial displacement from the central bundle axis.

### CROSS-REFERENCE TO RELATED APPLICATIONS/PRIORITY CLAIMS

The present application is a continuation of U.S. application Ser. No. 16/406,905 filed May 8, 2019 under the title FOVEAL IMAGE INVERTER, which was a continuation of U.S. application Ser. No. 15/410,727 filed Jan. 19, 2017 under the title FOVEAL IMAGE INVERTER, now U.S. Pat. No. 10,288,803, which was a non-provisional patent application based on U.S. Provisional Application Ser. No. 62/441,491 filed Jan. 2, 2017 and U.S. Provisional Application Ser. No. 62/281,168 filed Jan. 20, 2016. The present application claims the benefit of the filing dates of the foregoing patent applications and incorporates herein their disclosures by reference.

### BACKGROUND

The transmission of images and, more generally, electromagnetic waves, through bundles comprised of adjacently fused optical fibers is an established art. Image conduits such as inverters (i.e., image inverters), tapers and “straight-throughs” are well known to practitioners of the fiber optic arts. Fused optical fiber image conduits find broad application as components in such devices as night visions goggles, rifle scopes, x-ray detectors and medical imaging apparatuses, by way of non-limiting example.

The basic fabrication techniques of each of the examples listed above have process steps in common. For instance, the most basic of fused optical fiber image conduits is a one-to-one, linear conduit having an input (e.g., image receiving) end and an output (e.g., image emitting) end. Light reflected from an object adjacent the input end enters the input end as an image. The image is conducted through the conduit and exits the output end from which a detector device or human eye senses it. In a simple one-to-one conduit, the image exits the output end without intentional alteration. For instance, the image is not magnified, reduced or angularly displaced about the longitudinal axis of the conduit.

Referring to FIGS. 1A and 1B, as is known in the art, a basic one-to-one image conduit (FIG. 1A) is an intermediate product in the fabrication of an inverter (FIG. 1B). To fabricate an inverter, a one-to-one conduit is heated to an appropriate temperature. One end of the conduit in then angularly displaced (i.e., twisted) about the longitudinal axis of the conduit with respect to the opposite end. In the case of an inverter, the one end is twisted 180 degrees with respect to the other end. When properly controlled and executed, this process produces an inverter in which the original configuration of the face at each of the input and output ends is maintained, but in which one end is inverted with respect to the other. Accordingly, an image entering the image-receiving end is rotated as it is conducted through the constituent fibers within the fused bundle and exits the image-emitting end inverted.

It will be readily appreciated that, as the heated bundle is twisted to angularly displace about the longitudinal axis of the conduit one end with respect to the opposite end, constituent fibers within the bundle are stretched lengthwise. Moreover, fibers that are more toward the periphery of the bundle are stretched to a greater extent than fibers that are more centrally located. As a result, fibers more toward the periphery decrease in diameter more dramatically than do fibers more toward the center, particularly in central regions along their lengths. Because, according to traditional fabrication methods, the constituent fibers of the bundle are all of the same cross-sectional dimensions, peripheral fibers are sometimes stretched and constricted to such an extent that their ability to transmit light efficiently is negatively impacted, which results in undesired image effects, including vignetting. One way of avoiding image-degrading constriction of peripheral fibers is to twist the bundle the desired number of angular degrees over a longer bundle length. However, this results in bundles that may be too long, heavy and unwieldy for use in the intended environment or application.

Accordingly, a need exists for a fused fiber bundle and method of forming an inverter from the same that facilitates image inversion over a relatively short bundle length while obviating the undesired peripheral image degradation associated with previous fused-bundle image inverters.

### SUMMARY

An illustrative embodiment of an imaging-conducting optical fiber bundle extends longitudinally along a central bundle axis between an image input end and an image output end. Between the opposed image input and output ends there extends a plurality of mutually and adjacently fused constituent optical fibers. Each constituent optical fiber has a first end coinciding with the image input end and a second end coinciding with the image output end. In various embodiments, each constituent optical fiber is configured as an imaging fiber capable of conveying an infinitesimal portion of an input image from the between the image input and image output ends. Moreover, the optical fiber bundle is twisted about the central bundle axis and along a portion of its length such that an image inputted into the image input end is angularly displaced about the central bundle axis before being outputted through the image output end.

In keeping with general convention, each constituent optical fiber includes an optically transmissive core about which there is collapsed and fused an optical cladding, the core and cladding having relative indices of refractive that facilitate propagation of electromagnetic waves through the core by means of total internal reflection. The cladding is defined by a cladding diameter that corresponds with the fiber diameter, while the core is defined by a core diameter. The ratio of the core diameter to the cladding diameter defines a core-to-clad diameter ratio relative to each fiber.

In some versions, the fiber diameters of the constituent optical fibers increase as a function of radial displacement from the central bundle axis. That is, as viewed into a selected cross-section of the bundle taken orthogonally to the central bundle axis, optical fibers more toward the outer boundary of the bundle have larger fiber diameters than do optical fibers more toward the central bundle axis.

In each of some alternative embodiments, the core-to-clad diameter ratios of the constituent optical fibers vary as a function of radial displacement from the central bundle axis. That is, optical fibers nearer the central bundle axis exhibit core-to-clad diameter ratios disparate by design from the core-to-clad diameter ratios of optical fibers situated more radially distant from the central bundle axis. In at least one version, as viewed into a cross-section of the bundle taken orthogonally to the central bundle axis, the core-to-clad diameter ratios of the plural constituent optical fibers are configured to decrease as a function of radial displacement from the central bundle axis. In still more specific alternative versions in which core-to-clad diameter ratios vary as a function of radial position relative to the central bundle axis, the fiber diameters of the constituent optical fibers may be configured, in one case, to remain constant as a function of radial displacement from the central bundle axis and, in another case, to vary as a function of radial displacement from the central bundle axis.

Representative embodiments are more completely described and depicted in the following detailed description and the accompanying drawings.

### BRIEF DESCRIPTION OF THE DRAWINGS

FIG. 1A depicts a linear fused image conduit of the existing art, which is also referred to as a “straight through;”

FIG. 1B shows a fused optical fiber image-inverting conduit of the existing art;

FIG. 2 schematically depicts a cross-section of an optical fiber bundle, including an image-inverting optical fiber bundle, embodying aspects of the present invention in which fiber diameter varies as a function of radial displacement from the central bundle axis;

FIG. 2A is a side perspective view of an image-inverting optical fiber bundle fabricated in accordance with the present invention;

FIG. 3 is a schematic cross-section an image-inverting optical fiber bundle in which fiber diameter is constant but core diameter varies as a function of radial displacement from the central bundle axis; and

FIG. 4 is a schematic cross-sectional illustration of an alternative image-inverting optical fiber bundle in which fiber diameter is constant but core diameter varies as a function of radial displacement from the central bundle axis.

### DETAILED DESCRIPTION

The following description of variously embodied foveal image inverters and methods of fabricating the same is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to define the maximum scope of the claims.

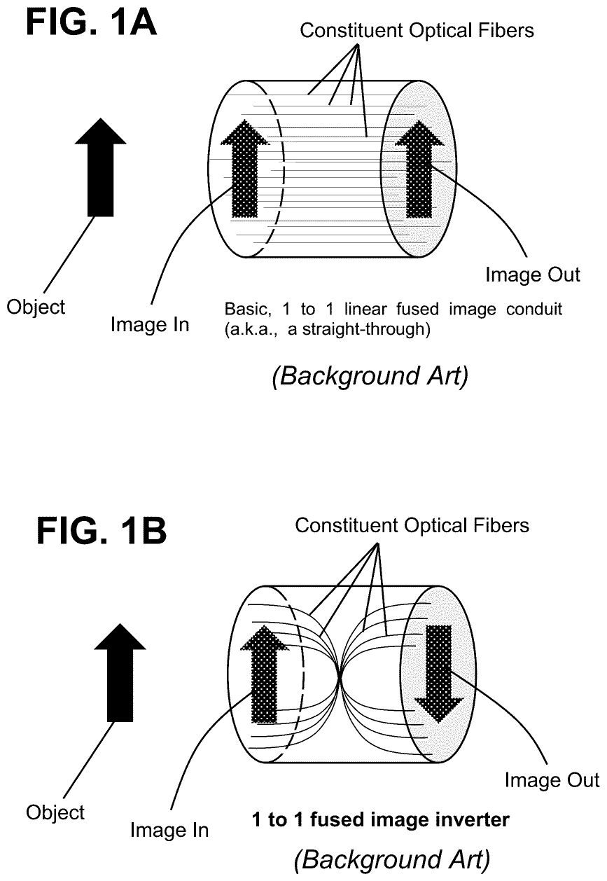

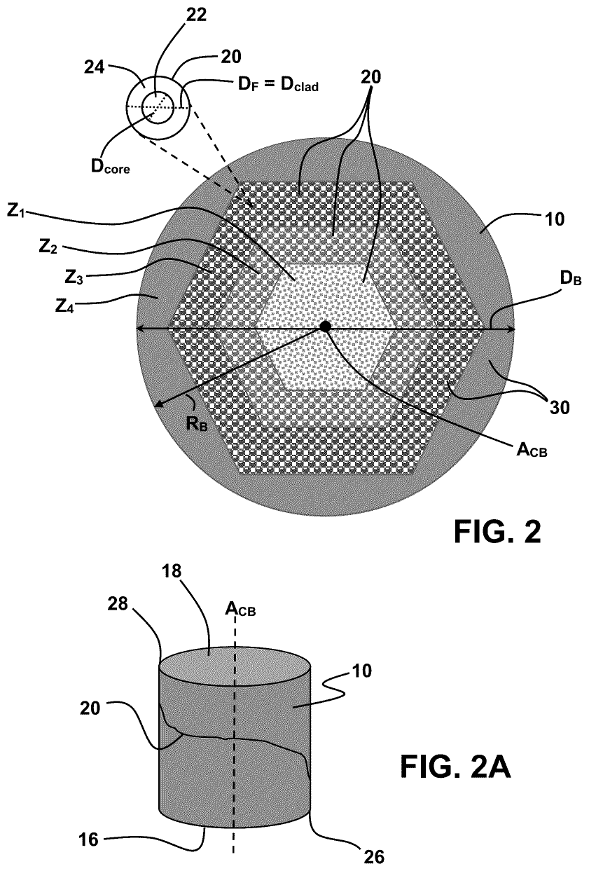

Many of the steps relative to the fabrication of a standard fused optical fiber bundle, including the special case of a fused-bundle image inverter, are applicable to the fabrication of optical fiber bundles and image inverters within the scope and contemplation of the present invention. These steps were summarized in the background with conjunctive reference to FIGS. 1A and 1B. Accordingly, principal reference is made to FIG. 2 for purposes of describing fundamental differences between standard fused optical fiber bundles, including standard fused-bundle image inverters, and foveal optical fiber bundles and image inverters within the scope and contemplation of the present invention as defined in the claims appended hereto. To the extent that the standard optical fiber bundles of FIGS. 1A and 1B include elements in common with embodiments within the scope of the invention, they may be referred to in order to support disclosure of the same.

Shown schematically in FIG. 2 is a cross-section of a rigid image-conducting optical fiber bundle 10 comprising a plurality of constituent optical fibers 20 and extending lengthwise along a central bundle axis A_{CB} between image-input and image-output ends 16 and 18. Each optical fiber 20 includes a core 22 and a cladding 24 extending between a fiber first end 26 and a fiber second end 28 coinciding with, respectively, the image-input and image-output ends 26 and 28 of the optical fiber bundle 10.

In various aspects, the core 22 and the cladding 24 comprise optically-transmissive materials of differing indices of refraction, thereby facilitating internal reflection, as is known in the art. In alternative versions, at least one of the core 22 and cladding 24 comprises a glass. However, within the scope and contemplation of the invention are embodiments in which at least one of the core 22 and cladding 24 comprises a polymeric material (e.g., a plastic). In alternative variations in which at least one of the core 22 and cladding 24 is fabricated from a polymer, the cladding 24 and core 22 of each optical fiber 20 may be mutually joined or “fused” by, for example, heat fusion, as is typical of glass fibers, or by an alternative means such as an optical epoxy. Similar alternative methods may be used to join plural optical fibers 20 within the optical fiber bundle 10 to one another. In still additional versions, optical fibers 20 each of which comprises as least one of a glass and a polymer, may be retained in their respective positons within the overall optical fiber bundle 10 by a matrix 30 independent of the material from which the claddings 24 are formed. The matrix 30 could comprise, by way of example, a polymer, glass and/or optical epoxy.

Because a schematic cross-section is under consideration, it will be readily understood that the optical fiber bundle 10 could be either a straight-thru or an image inverter since planar cross-sections of these types of fused bundles could be indistinguishable. Moreover, while the constituent optical fibers 20 of the optical fiber is bundle 10 in FIG. 2 are hexagonally packed, it is to be understood that the overall inventive concept encompasses numerous alternative fiber-packing arrangements, such as, by way of non-limiting example, circular/cylindrical, square, rectangular, etc., and that the packing arrangement is not at the precise point of novelty. A similar observation applies to the cross-sectional geometry of the constituent optical fibers 20 themselves. In fact, in addition to circular/cylindrical, square, rectangular, hexagonal, etc., at least one embodiment envisions use of five-sided fibers 20 in order to, in part, allow for the inclusion of interstitial EMA (extramural absorption) fibers among the optical fibers 20 within the bundle 10. Accordingly, and importantly, because the optical fibers 20 and bundles 10 may be of various cross-sectional geometries, the use of the term “diameter” not imply a circular cross-sectional geometry. More specifically, although “diameter” is frequently thought of narrowly as the longest chord that can be fitted within the curve defining a circle, the more technical mathematical definition of that term is applicable to this description and the appended claims. For instance, chords within squares, rectangles, hexagons, and even, irregular shapes are also diameters. Accordingly, nothing in the preceding explanation, the detailed description, the appended claims or the drawings should be construed to attribute to the term “diameter” a meaning more narrow than common usage and technical mathematical usage would attribute to them. Moreover, “radius” is in all cases, unless otherwise specified, as half the length of a given diameter.

Representative of the inventive concept is the inclusion with the optical fiber bundle 10 of a plurality of fiber zones Z₁ through Zₓ concentrically arranged about the central bundle axis A_{CB}, wherein Z₁ is the fiber zone located closest to and/or including the central bundle axis A_{CB} and Zₓ is the “outermost” fiber zone (i.e, the fiber zone radially most distant from the central bundle axis A_{CB}). Moreover, the fiber zones Z₁ through Zₓ are populated by optical fibers 20, the fiber diameters D_{F} of which are zone dependent. More specifically, the average overall fiber diameter D_{F} of constituent optical fibers 20 within the first fiber zone Z₁ is smaller than the average overall fiber diameter D_{F} of constituent optical fibers 20 within each fiber zone more radially distant from the A_{CB}. More generally, the average overall fiber diameter D_{F} of the optical fibers 20 within each fiber zone is greater (larger) than the average overall fiber diameter D_{F} of the optical fibers 20 within each fiber zone closer to the central bundle axis A_{CB} and less (smaller) than the average overall fiber diameter D_{F} of the optical fibers 20 within each fiber zone more radially distant from the central bundle axis A_{CB}.

By way of concrete non-limiting example, the illustrative optical fiber bundle 10 of FIG. 2 includes four “fiber zones” referenced as Z₁, Z₂, Z₃ and Z₄ (x=4 in this case). Fiber zone Z₁ (the innermost “central zone′) includes optical fibers 20 having the smallest fiber diameters D_{F} (e.g. 2.0-3.0 microns). Fiber zone Z₂ is the first zone concentrically disposed about fiber zone Z₁ and includes optical fibers 20 of incrementally larger fiber diameter D_{F} (e.g. 3.0-6.0 microns) than the optical fibers 20 of fiber zone Z₁. Concentrically disposed about fiber zone Z₂ is fiber zone Z₃ which is comprised of optical fibers 20 of still larger fiber diameter D_{F} (e.g., 6.0-10.0 microns). The outermost zone, fiber zone Z₄, which is concentrically disposed about fiber zone Z₃, includes optical fibers 20 with the largest overall fiber diameter D_{F} in the bundle 10 (e.g. 10.0-12.0 microns).

Referring still to the cross-sectional view of FIG. 2, and most particularly the enlarged view of a constituent optical fiber 20, each optical fiber 20, regardless of the fiber zone Z₁ through Zₓ with which it is associated, has a core 22 with a core diameter D_{core} and a cladding with a cladding diameter D_{clad}. Since, at least among some embodiments, it is the “outer diameter” of the cladding 24 that is relevant, and designated as the cladding diameter D_{clad}, the cladding diameter D_{clad} may, in various aspects, be viewed as synonymous with the fiber diameter D_{F}. In any event, while the fiber diameters D_{F} themselves increase as a function of fiber zone Z and bundle radius RB, various embodiments are configured such that the core-to-clad diameter ratio R_{CC}, defined as D_{core}/D_{clad}, is held constant across fiber zones Z₁ through Zₓ.

Another way of conceptualizing the core-to-clad diameter ratio R_{CC} is in terms of the cross-sectional area of a constituent optical fiber 20 that each of the core 22 and cladding 24 of the same represents. For example, consider first and second optical fibers 20 with the same cladding diameter D_{clad}. If the first optical fiber 20 has a core diameter D_{core} that is smaller than the core diameter D_{core} of the second optical fiber 20, then the first optical fiber 20 has a smaller core-to-clad diameter ratio R_{CC} than the second optical fiber 20. Expressed in alternative terms, for an optical fiber 20 of a given cladding diameter D_{clad}, an increase in the core diameter D_{core} corresponds to the core 22 representing an increased percentage of the overall cross-sectional area of the optical fiber 20 and the cladding 24 representing a correspondingly decreased percentage of the cross-sectional area of the optical fiber 20.

Relative to the formation of an optical fiber bundle 10 in which the output image is angularly displaced relative to the input image, it will be appreciated that an arrangement of optical fibers 20 to form a fiber bundle 10 such as that in FIGS. 2 and 2A facilitates a greater “twist rate” because the larger-diameter optical fibers 20 in the fiber zones more distant from the central bundle axis A_{CB}, while being elongated the most during the twist, are not constricted down to such a small fiber diameter D_{F} that their light-transmission capabilities are negatively impacted. Because the “twist rate” can be much greater using the present solution, image-inverting optical fiber bundles 10 of much shorter overall length are rendered possible. Moreover, the resolution of the inverted image can be made constant across the bundle diameter DB by not degrading appreciably as a function of radial displacement from the central bundle axis A_{CB}.

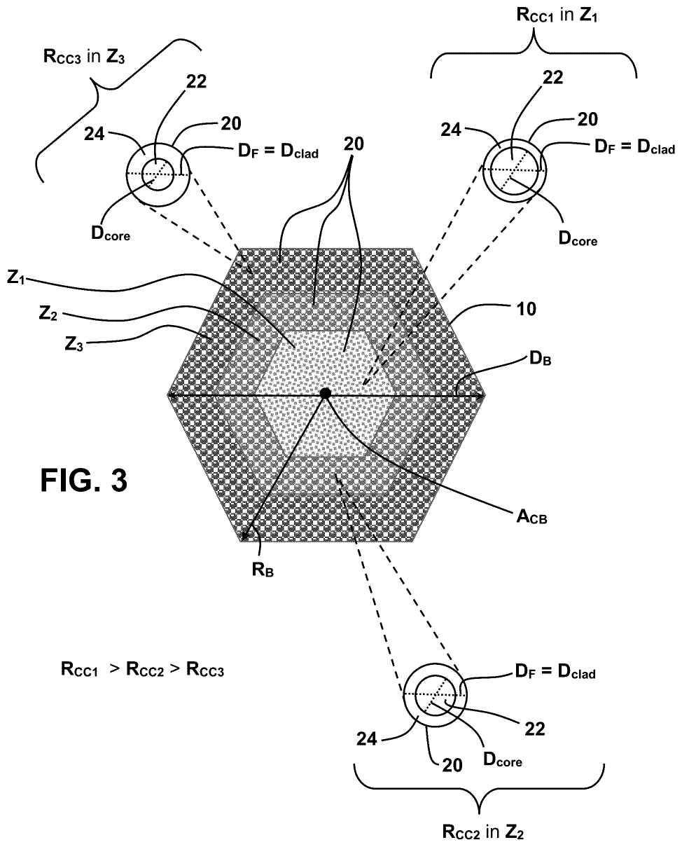

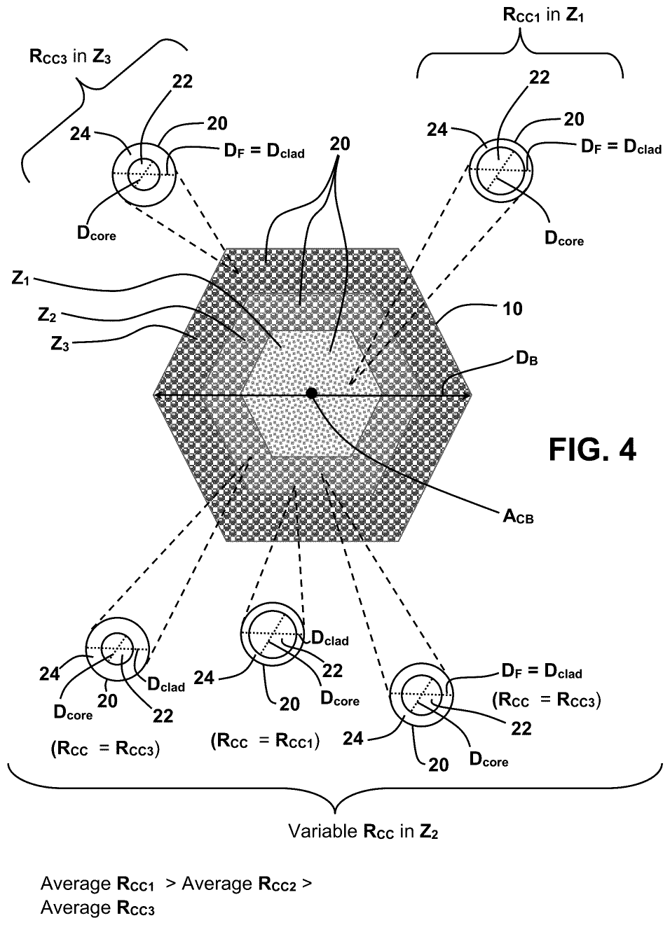

In accordance with an alternative configuration, fiber diameter D_{F} is held constant among and across fiber zones Z₁ through Zₓ, while the core-to-clad diameter ratio R_{CC} varies as a function of fiber zone Z. In one version, an innermost first fiber zone Z₁ comprises optical fibers 20 with a relatively high core-to-clad diameter ratio R_{CC}, an outermost third fiber zone Z₃ with a relatively low core-to-clad diameter ratio R_{CC}, and at one intermediate second fiber zone Z₂ situation between the innermost and outermost fiber zones Z₁ and Z₃ and comprising optical fibers 20 with a core-to-clad diameter ratio R_{CC} between the core-to-clad diameter ratios R_{CC} of the first and third fiber zones Z₁ and Z₃. In some such versions, the optical fibers 20 within each fiber zone Z are configured in accordance with a uniform specification to have the same core-to-clad diameter ratio R_{CC} throughout the zone Z. However, in other variants, there is a mix within at least one fiber zone Z of optical fibers 20 having disparate core core-to-clad diameter ratios R_{CC}. Examples of two alternative configurations of bundles 10 having variable core core-to-clad diameter ratios R_{CC} across fiber zones Z are discussed in further detail below with conjunctive reference to the schematically-represented bundle cross-sections shown in FIGS. 3 and 4.

Referring now to FIG. 3, there is shown a cross-section of a rigid image-conducting optical fiber bundle 10 comprising a plurality of constituent optical fibers 20 generally situated in first, second, and third fiber zones Z₁, Z₂, and Z₃. Within each fiber zone Z₁, Z₂, and Z₃ the core-to-clad diameter ratios R_{CC} are constant, but they are disparate among the fiber zones Z. More specifically, within the first, second, and third fiber zones Z₁, Z₂, and Z₃, the core-to-clad diameter ratios R_{CC} are, respectively, R_{CC1}, R_{CC2}, and R_{CC3}. In this particular case, the fiber diameters D_{F} are constant across the entire bundle 10. That is, the cladding diameters D_{clad} are constant among the first, second, and third fiber zones Z₁, Z₂, and Z₃ so that the variance in the core-to-clad diameter ratios R_{CC1}, R_{CC2}, and R_{CC3} is attributable to variance among the core diameters D_{core} across the first, second, and third fiber zones Z₁, Z₂, and Z₃. More specifically, as generally indicated in FIG. 3, although not precisely tied to any particular scale, the cores 22 of the optical fibers 20 in the first fiber zone Z₁ are configured with the largest core diameter D_{core}, the cores 22 of the optical fibers 20 in the second fiber is zone Z₂ have the second-largest core diameter D_{core}, and cores 22 of the optical fibers 20 in the third fiber zone Z₃ have the smallest core diameter D_{core}. Given the constant cladding diameter D_{clad} across all fiber zones Z, it follows that R_{CC1}>R_{CC2}>R_{CC3} and indicated in FIG. 3.

With reference to FIG. 4, another variation of an embodiment with various core-to-clad diameter ratios R_{CC} is briefly described. Although numerous permutations within the overall scope and contemplation of the invention are possible, a broader overall concept is represented more simplistically through a discussion of FIG. 4. Like the illustrative example of FIG. 3, the example of FIG. 4 generally includes first, second, and third fiber zones Z₁, Z₂, and Z₃. Moreover, as with the example of FIG. 3, and in order to keep the example manageable and simple, the cladding diameters D_{clad} are constant among the first, second, and third fiber zones Z₁, Z₂, and Z₃ so that any variance in the core-to-clad diameter ratios R_{CC} among optical fibers 20 is attributable to variance among the core diameters D_{core}.

A key difference between the examples of FIGS. 4 and 3 is that, in the example of FIG. 4, there is, by design, a variance in the core-to-clad diameter ratio R_{CC} within at least an intermediate zone (e.g., fiber zone Z₂ in this case). While there may be some variance in the core-to-clad diameter ratio R_{CC} within each of the fiber zones Z, or across some radially-dependent gradient, for simplicity, a variance within only fiber zone Z₂ is considered. While the first fiber zone Z₁ includes only optical fibers 20 with a first core-to-clad diameter ratio R_{CC1} and the third fiber zone Z₃ includes only optical fibers 20 with a third core-to-clad diameter ratio R_{CC3} lesser in magnitude than the first core-to-clad diameter ratio R_{CC1}, the second fiber zone Z₂ includes a mixture of core-to-clad diameter ratios R_{CC}. In this particular case, as illustrated by the three demonstrative fiber cross-sections just above the bracket labeled “Variable R_{CC} in Z₂,” there are within fiber zone Z₂ optical fibers 20 characterized by the first, second, and third core-to-clad diameter ratios R_{CC1}, R_{CC2}, and R_{CC3}. Whereas the second core-to-clad diameter ratio R_{CC2} is unique to the second fiber zone Z₂ in this configuration, as previously mentioned, the first fiber zone Z₁ is populated entirely by optical fibers 20 of the first core-to-clad diameter ratio R_{CC1}, while the third fiber zone Z₃ is populated entirely by optical fibers 20 of the third core-to-clad diameter ratio R_{CC3}.

Whether or not the second fiber zone Z₂ of any particular embodiment includes fibers 20 of a second core-to-clad diameter ratio R_{CC2} unique to the second fiber zone Z₂, the inclusion within the second fiber zone Z₂ of a mixture of optical fibers 20 exhibiting both the first and third core-to-clad diameter ratio R_{CC1} and R_{CC3} results in a smoother, less obvious transition between fibers 20 of the first and third fiber zones Z₁ and Z₃. Optical fibers 20 of disparate core-to-clad diameter ratio R_{CC} may be randomly distributed in the second fiber zone Z₂ or well ordered. In at least one configuration, the inclusion within the second fiber zone Z₂ of optical fibers 20 of the first core-to-clad diameter ratio R_{CC1} is more dense nearer the first fiber zone Z₁, while the inclusion in the second fiber zone Z₂ of optical fibers 20 of the third core-to-clad diameter ratio R_{CC3} is more dense nearer the third fiber zone Z₃ thereby defining a sort of radially-dependent inclusion gradient of disparate core-to-clad diameter ratios R_{CC} within the bundle 10. In addition to avoiding visible “steps” between fiber zones Z, the inclusion of optical fibers 20 of disparate core-to-clad diameter ratio R_{CC} in different concentrations across the cross-section of the bundle 10 in accordance with a radial gradient mitigates structural stresses associated with the heating, drawings and twisting steps, and with the differing effects of thermal expansion on disparate fiber types.

Because variances in core-to-clad diameter ratios R_{CC} even within each fiber zone Z are envisioned, it may be useful to conceptualize the core-to-clad diameter ratio R_{CC} within any particular fiber zone Z as representative of an average core-to-clad diameter ratio R_{CC} applicable to that zone, and the averages among all fiber zones Z as decreasing with radial displacement from the central bundle axis A_{CB}. In accordance with this conceptualization, FIG. 4 indicates that “average R_{CC1}>average R_{CC2}>average R_{CC3}. In a manner similar to integration in calculus, as the number of annular fiber zones Z becomes very large, and the annular thickness of each fiber zone Z becomes very small, the more arbitrary the designation of individual fiber zones Z becomes, and the radially dependent gradient fiber inclusion becomes increasingly “smooth.”

Beyond the preceding, it is to be understood that, within any given configuration, variances in overall fiber diameter D_{F} and core-to-clad diameter ratios R_{CC} are not mutually exclusive. More specifically, while the description up to the present has considered alternative configurations in which, on the one hand, fiber diameter D_{F} varies as a function of radial displacement from the central bundle axis A_{CB} while core-to-clad diameter ratio R_{CC} is constant across the bundle 10 and, on the other hand, fiber diameter D_{F} is constant across the bundle 10 while core-to-clad diameter ratio R_{CC} varies as a function of radial displacement from the central bundle axis A_{CB}, expressly within the scope and contemplation of the invention are bundle configurations in which both fiber diameter D_{F} and core-to-clad diameter ratio R_{CC} varies as a function of radial displacement from the central bundle axis A_{CB}.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

1. An image-conducting optical fiber bundle having an image input end and an image output end, the bundle comprising:
a plurality of adjacently constituent optical fibers, each optical fiber having a first end coinciding with the image input end and a second end coinciding with the image output end, wherein
(i) the bundle extends longitudinally along a central bundle axis; and
(ii) the bundle includes a plurality of at least two fiber zones including at least a first fiber zone and a second fiber zone, the first and second fiber zones being concentrically arranged about the central bundle axis and defined such that (a) the first fiber zone is nearer the central bundle axis than is the second fiber zone and (b) the average overall fiber diameter of constituent optical fibers within the first fiber zone is smaller than the average overall fiber diameter of constituent optical fibers within the second fiber zone.

2. The optical fiber bundle of claim 1 wherein each fiber zone is populated by a plurality of optical fibers configured in accordance with a uniform specification relative to at least one of fiber diameter and core-to-clad ratio.

3. The optical fiber bundle of claim 1 wherein each optical fiber has a fiber diameter and includes a cladding with a cladding diameter corresponding with the fiber diameter of that optical fiber and a core with a core diameter,
